(19) United States
(12) Patent Application Publication
(10) Pub. No.: US 2014/0228484 A1
(43) Pub. Date: Aug. 14, 2014

(54) POLYMER, PROCESS AND USE

(71) Applicants: Echt Petronella Friederichs, Echt (NL); Jacobus Adriaan Antonius Vermeulen, Echt (NL); Marco Marcus Matheus Driessen, Echt (NL); Johan Franz Gradus Antonius Jansen, Echt (NL); Jan Hendrikus Udding, Zwolle (NL)

(72) Inventors: Echt Petronella Friederichs, Echt (NL); Jacobus Adriaan Antonius Vermeulen, Echt (NL); Marco Marcus Matheus Driessen, Echt (NL); Johan Franz Gradus Antonius Jansen, Echt (NL); Jan Hendrikus Udding, Zwolle (NL)

(73) Assignee: DSM IP ASSET B.V., Heerlen (NL)

(21) Appl. No.: 14/128,174

(22) PCT Filed: Jun. 21, 2012
(86) PCT No.: PCT/EP2012/061991

§ 371 Date: Apr. 28, 2014

(30) Foreign Application Priority Data
Jun. 21, 2011 (EP) 11170717.0
Feb. 29, 2012 (EP) 12157485.9

(51) Int. Cl. C08G 69/26; C09D 175/04; C04B 24/28; C09D 177/06

(52) U.S. Cl. CPC C08G 69/26; C09D 177/06; C09D 175/04; C04B 24/287
USPC 524/5; 528/345; 528/336; 525/451; 524/606; 524/379; 525/183; 524/590

(57) ABSTRACT

There is described a process for producing a gel free hyperbranched polyamide polymer P having a polydispersity of at least 1.1 and a weight average molecular weight of at least 300 daltons, having primary amino groups (useful as a crosslinker). The process comprises the step of reacting Reagent A, a compound comprising at least one amino group (—NH₂) and one functional group selected from the group consisting of a further amino group (—NH₂), thiol (—SH) and a secondary amine radical (—NHR); (where R denotes a hydrocarbo group) (=functional amine) and Reagent B, an alpha-beta unsaturated Michael-reactive ester comprising a plurality of ester groups (=diester); in a molar ratio of amine A to diester B greater than 1 but less than 3 (preferably 2.1 to 2.9); to form the polyamide in a two stage reaction Michael addition and then amidation. The amine in kept in excess with at least 5% of water by total weight of the amine and diester, a reaction temperature less than the boiling point of the amine; and is held under reduced pressure (30 mbar to 1 atms). Gelation does not occur even after substantially all ethylenic (—C═C—) double bonds; and >95% ester [—C(O)═O] groups have reacted. This violates the Flory rules which predict a gel would form based on the number of functional groups present and their degree of conversion. These polymers may be used as a replacement for polyethylene imine (PEI) for example on plastics; in coatings, colours and/or adhesives; with metals; on textiles and fibres; in water treatment, paper, mineral processing and/or chemically modified Various chemical modifications and further reactions of these polymers are also described. A diverse range of other uses are also described including as additives for composite compositions, such as specialty additives for super-plasticizers in concrete admixtures.

The present invention relates to the field of polymers that comprise amino groups, such as polyamides comprising amino groups, especially hyperbranched polyamides, compositions comprising them and various uses thereof.

It had long been believed that any primary amine group present in a polyester amide would undergo intermolecular amidation with the ester groups. As a result hyperbranched polyester amide polymers with primary amine end groups have not been available.

Recently the applicant discovered a surprisingly simple method to prepare polyamides that comprise primary amino groups. This method is described in co-pending patent application WO2011-076785 (the relevant passages of which are incorporated herein by reference). At least one diamine and at least one unsaturated diester are reacted in a molar ratio of diamine to diester greater than 1 but less than 3 (preferably 2.1 to 2.9); to form the polyamide in a two stage reaction of Michael addition and amidation. Gelation does not occur even after substantially all ethylenic (—C═C—) double bonds; and >95% ester [—C(O)═O] groups have reacted. This violates the Flory rules which predict a gel would form based on the number of functional groups present and their degree of conversion. Surprisingly this process can produce a gel free hyperbranched polyamide polymer having primary amino groups. The theoretical background to this aspect of the process is described more fully on page 3, line 23 to page 5, line 27 of WO2011-076785 (and this section is incorporated herein by reference). For convenience the polyaminoamides described in WO2011-076785 are referred to herein as Polymer N (in contrast to polymers of the present invention which are referred to herein as Polymer P).

The present invention relates to developments and improvements to this new process, new polymers and new uses.

Broadly in accordance with one aspect of the present invention there is provided a process for the preparing a substantially gel free non dendritic polymer P having a polydispersity of at least 1.1 and a weight average molecular weight of at least 300 daltons, the polymer P comprising at least one primary amino group, the process comprising the step of reacting

Reagent A, a compound comprising at least one amino group (—NH₂) and one functional group selected from the group consisting of a further amino group (—NH₂), thiol (—SH) and a secondary amine radical (—NHR); (where R denotes a hydrocarbo group) and

Reagent B, an alpha-beta unsaturated Michael-reactive ester comprising a plurality of ester groups; where the molar ratio (denoted by Rt) of Reagent A to Reagent B is more than one and less than three, preferably from 1.1 to 2.9. Other preferred values for Rt are described herein.

Reagent A is preferably other than an aromatic primary amine (such as 1,3,5-triaminobenzene). More preferably Reagent A is a compound comprising one amino group (—NH₂) and one functional group selected from the group consisting of a thiol (—SH) and a secondary amine radical (—NHR); (where R denotes a hydrocarbo group) and where optionally Reagent A does not comprise a second or further amino groups.

The invention herein disclaims those polymers (denoted herein as Polymer N) and processes already described in WO2011-076785 (but not new uses of Polymer N). Polymer N is prepared by a process for the preparing a substantially gel free polymer (i.e. not a dendrimer) comprising primary amino groups, the process comprising the step of reacting Reagent A, a compound comprising at least two amino groups; and Reagent B, an unsaturated ester comprising a plurality of ester groups; where the molar ratio (denoted by Rt) of Reagent A to Reagent B is more than one and less than three.

Broadly in accordance with one embodiment of the process of present invention there is provided a process for producing an (optionally hyperbranched) polyamide polymer P having polydispersity at least 1.1 and a weight average molecular weight of at least 300 daltons, that comprises one amino group (—NH₂) and one group selected from another amino group (—NH₂), thiol (—SH) and/or a secondary amine radical (—NHR, where R denotes a hydrocarbo group); the process comprising the step of reacting

Reagent A comprising at least one aminoC₁₋₁₂hydrocarbon (preferably a aminoC₁₋₁₀alkane) substituted by at least one thiol and/or secondary amine radical; and

Reagent B comprising at least one di(C₁₋₁₂hydrocarbo-oxy)C₃₋₁₀hydrocarbo-enedioate (preferably a di(C₁₋₆alkoxy)C₄₋₆alkenedioate)ester) and/or anhydride thereof;

where Rt is in the range from 1.1. to 2.9 (or as given elsewhere herein); and optionally where the reaction is carried out in the presence of Reagent C to form as a product a (non dendrimer) polymer comprising one or more primary amino groups where

Reagent C is capable under the conditions of the reaction of cleaving ester [—C(O)═O] bonds to form moieties which are not capable of undergoing Michael addition.

Preferred polymers of the invention are polyaminoamides (and/or their thio equivalent) and are substantially free of moieties where an aromatic group is directly attached to an amino group.

Preferred polymers of the invention are non-dendrimeric and have a polydispersity of at least 1.1, more preferably at least 1.2, most preferably at least 1.3.

In a preferred process of the invention Reagent A comprises a compound comprising at least one amino group (—NH₂) and one functional group selected from the group consisting of a further amino group (—NH₂), thiol (—SH) and a secondary amine radical (—NHR); (where R denotes a hydrocarbo group).

In another aspect of the invention the process is performed in the presence of Reagent C in sufficient amounts to avoid gelation. It will be appreciated that the exact amount of Reagent C needed will depend on the specific Reagents A and B that are used and this amount can be determined for any combination of Reagents without undue experimentation.

Reagent C may be any suitable nucleophile (i.e. ester cleaving agent), such as NH₃, H₂O and/or NHAr (where Ar denotes an optionally substituted aromatic moiety where the NH is attached directly to an aromatic ring). More preferably Reagent C is in liquid form optionally as solvent for the reaction (e.g. as liquid ammonia or water). Without wishing to be bound by any mechanism it is believed that Reagent C may react with some of the intermediate products of the reaction and perhaps lower the actual amount of functional groups present to avoid gelation.

If Reagent C is water the reaction is carried out in the presence of a sufficient amount of water in order to prevent gelation. Without being bound by the hydrolysis theory, the applicant has assumed that after 24 hrs at least 15% of the ester groups are hydrolysed, and that the equilibrium has just been established. This implies that for methyl esters 1.8% by weight of water may be sufficient to prevent gelation. Based on these assumptions and following the analysis of J. R. Robson and L. E. Matheson, (J. org. Chem. Vol 34, no 11, p 3630, y 1969) this means that for ethyl esters the minimal amount to prevent gelation may be at least 7.2%, for n-propyl esters the amount may be at least about 9% water and for n-butyl esters at least 12% water may be sufficient.

Using secondary esters like for instance i-propyl esters it is believed that significantly higher amounts of water will be needed; for i-propyl esters up to 90% by weight of the reagents may be water. According to this analysis t-butyl esters hydrolyse at a slow rate. So it is preferred that at least one of the esters of the dialkyl ester is a primary ester, such as n-alkyl ester more preferably a C₁₋₁₀alkyl ester, most preferably C₁₋₄alky ester, for example methyl or ethyl ester. Even more preferred both alkyl esters are n-alkyl esters, most preferably both are C₁₋₄alkyl esters, more preferably both are methyl or ethyl esters.

In general it is preferably that more than 10% water more preferably more than 15% water is present in the reaction.

Analogous calculations can be readily performed by a person skilled in the art to determine for a given alkyl ester the minimum amount of reagent C as a weight percentage that may be present if reagent C is other than water (e.g. liquid ammonia).

One embodiment of the process of the invention is performed in the presence of Reagent C (for example water or liquid ammonia) in an amount at least 0.01 moles (based of the total moles of Reagents A and B), preferably at least 0.05 moles, conveniently at least 0.1 moles, more preferably at least 0.2 moles, most preferably at least 0.5 moles.

In another embodiment of the process of the invention the amount of Reagent C present may also be calculated as a ratio of functional groups (Rc) based on the total number of ester cleaving functional groups present on Reagent C compared to the total amount of ester groups present in Reagent B. Rc may preferably be at least 0.01 more preferably at least 0.05, conveniently at least 0.1, more preferably at least 0.2, most preferably at least 0.5.

In an another embodiment of the process of the invention is performed in the presence of Reagent C in an amount by weight (based of the total amount of Reagents A and B) of at least 3.0%, conveniently of at least 5.1% and less than 23.3%, more preferably from 5.5% to 22% by weight, most preferably from 6% to 20%, usefully 7% to 15%, more usefully from 8% to 12%, for example about 10% by weight. Where Reagent C is ammonia or water it may be preferably present in an amount of at least about 5%, more preferably from 5.1% to 25%, even more preferably from 6% to 15%, most preferably from 7% to 10% by weight of the total amount of Reagents A and B in the process of the present invention.

Moles of Reagents A or B (and thus Rt) are calculated based on the moles of the whole reagent needed to provide a given amount of reacting groups. A reacting group of Reagents A or B is a group which under the conditions of the reaction is capable of undergoing a corresponding reaction with a group comprising the other of Reagents A or B (or intermediate products formed therefrom). So for example when Reagent A is a aminethiol and Reagent B is a monounsaturated diester then for Reagent A the reacting groups are the amino and thiol groups and there are two moles of reacting group (one amino and one thiol) per mole of Reagent A. For Reagent B the reacting groups are the single alpha-beta ethylenically unsaturation and the two ester groups so there would be three moles of reacting group per mole of Reagent B.

Preferably the reaction step is carried out at a temperature of greater than 0° C. and less than the boiling point of Reagent A, more preferably from 20° C. to the boiling point of Reagent A, and most preferably from ambient temperature to the boiling point of Reagent A. Further temperature preferences are described herein.

Optionally the reaction is carried out (at least in part) under reduced pressure, preferably less than one atmosphere. Further pressure preferences are described herein.

One embodiment of the process of the invention provides a method for obtaining polyamide polymers of polydispersity of at least 1.1 (not dendrimers) with a primary amino group which are substantially free of gel (infinite polymer network). As used herein the term non-dendrimer indicates a polymer which is not a single large dendrimer macromolecule made by a dendrimeritic process but has a non trivial polydispersity (e.g. >1.1).

Preferably the process of the invention is performed until the reaction mixture and/or product is substantially free, more preferably 100% free of ethylenic (—C═C—) double bonds. As used herein the term ethylenic (—C═C—) double bond denotes those capable of undergoing Michael addition (such as those alpha beta to the ester carbonyl group).

Preferably the process of the invention is performed until the reaction mixture and/or product comprises no more than 5% equivalents of the initial amount in the diester of ester [—C(O)═O] double bonds, more preferably is substantially free, most preferably 100% free of ester [—C(O)═O] double bonds.

Preferably at the end of the process at least 95%, more preferably at least 98%, most preferably at least 99%, for example 100% of the ethylenic (—C═C—) double bond in the initial diester are no longer measurable in the reaction mixture and/or product (this is also denoted herein as degree of conversion).

Preferably at the end of the process at least 95%, more preferably at least 98%, most preferably at least 99%, for example 100% of the ester [—C(O)═O] double bonds in the initial diesters are no longer measurable in the reaction mixture and/or product (this is also denoted herein as degree of conversion).

The relative amount of ester and/or ethylenically unsaturated double bonds present in the reaction mixture and/or product may be measured by any suitable technique for example by proton NMR and FTIR.

Broadly in another embodiment of the polymers of invention there is provided a substantially gel free (non dendrimer) polyamide comprising a primary amino group, the polyamide comprising repeat units derived from Reagent A and a Reagent B (as described herein) where the relative molar ratios of said repeat units is given by Rt (also as described herein).

The polyamide of the invention may be obtained and/or obtainable by a process of the invention as described herein

In another aspect of one embodiment of the invention there is provided a substantially gel free polyamide having primary amino groups therein where the polyamide comprising repeat units derived from unsaturated diester (preferably a trifunctional mono unsaturated diester) and repeat units derived from an amine and thiol and/or secondary amine (and/or amino acid comprising at least two of said groups) where the percentage of ester groups remaining in the polyamide is denoted by Pₑ and satisfies the relationship

Pₑ<√(α_{c}/r)

where α_{c}=1/(f−1) where f is the functionality of the ester derived repeat unit (which for a mono unsaturated diester is 3) and r is the ratio of the functional groups of the ester derived repeat unit to the functional groups of Reagent A (the amino, thiol and/or smino amine or amino acid derivatives thereof).

Thus polymers of the invention violate the Flory rules. Pₑ may be measured using proton NMR relative to the amount of diester used to prepare the polyamide.

The process of the invention uses an excess of Reagent A with respect to the diester and it is preferred to add the diester to Reagent A so Reagent A is always in excess.

It is preferred that the final product is substantially (more preferably completely) free of ester [—OC═O—] functional groups. This is desired so the amine group can co-exist on the polymer without intermolecular amidation which might lead to gelling.

Preferred polyamides of the invention may comprise three dimensional structures such as hyperbranched with polydispersity of at least 1.1 (i.e. not dendrimers) but other more linear structures such as graft polymers may also be prepared by the process of the present invention.

Preferred polyamides of the invention have a hyperbranched structure, primary amine functional groups and are highly reactive towards certain groups such as isocyanate. Prior art highly branched macromolecules (such as the hyperbranched polyester amides available commercially from DSM under the trade mark Hybrane® and the ester functional macromolecular material available commercially from Perstorp under the trade mark Boltorn®) contain ester groups and so undergo complete internal reactions between the ester and primary amine groups so that no primary amine groups remain on the final polymer.

The process of the present invention uses cheap starting materials which react quickly together and provides a new polycondensation route to obtain hyperbranched polyamides with primary amine groups.

Rt represents the Reagent A to diester mole ratio, so >1 means excess diamine. Rt may be from 1.1 to less than or equal to 2.9. Preferably 2.0≦Rt≦2.8. More preferably 2.1≦Rt≦2.7. Most preferably 2.15≦Rt≦2.67. For example Rt is from 2.2 to 2.6. In particular Rt is 2.5.

Conveniently Rt satisfies the relationship “Rt=(2n+1)/(n)” where 2n+1 is moles of amino plus thiol or secondary amine (also denoted as functional groups A) and n is moles of diester. The upper limit of n is not too high (upper limit of n is preferably 20, more preferably 15, most preferably 10) as when n→∞ then 2n+1→2n and the applicant has discovered that reacting Reagent A with diester in a molar ratio of ‘n’ “functional groups A” to ‘2n’ diester will produce a gel. More conveniently n is an integer selected from the inclusive range from 2 to 10, most conveniently from 2 to 8, in particular from 2 to 6. Most conveniently Rt is selected from one of the following mole ratios (diamine to diester): “5 to 2”; “7 to 3”, “9 to 4”; “11 to 5” or “13 to 6”.

Rt is preferably a measure of the initial molar ratio of Reagent A to a diester. If the ratio changes during the reaction it is preferred that this molar ratio Rₜ may be maintained by addition of further reagent. For example the reaction mixture may be heated to remove (by distillation) ethanol produced during the polycondensation (and help drive the equilibrium to the right) and/or the pressure of the reaction mixture can be reduced to remove ethanol. However heating or reducing pressure may also remove some Reagent A (especially if the amine has a low boiling point). Further amine may be added to the reaction mixture to keep the value of Rt within the desired range specified herein. If necessary this adjustment can be done automatically with the appropriate sensors and dosage equipment. It is preferred that the process of the present invention is carried out at a temperature less than the boiling point of the amine (or mixture of amines) used so that the molar ratio (Rt) is not significantly altered and no further amine need be added.

For comparison one preferred amine for use in the present invention is amine butane thiol (ABT)

The mole ratio (Rt) herein is calculated based on the initial number of moles of the whole molecule (i.e. amine or diester) and not the individual functional groups thereon.

The number of moles of diester is calculated as the number of moles of diester that would provide the equivalent of the three reactive functional groups thereon (two [—ROC═O)—] ester and one Michael reactive ethylenic bond). These are the 3 groups that are capable of reacting with the functional groups A (primary amino (—NH₂, thiol or secondary amine groups) on amine Reagent A.

The number of moles of Reagent A is calculated herein as the number of moles of Reagent A that would provide the equivalents of the two functional groups A thereon, i.e. is based on moles of the molecule and not its constituent functional A groups. So in both cases it is moles of the whole molecule not the reactive groups thereon that is used to calculate ratio Rt.

Advantageously the process of the invention may be performed at a temperature of 150° C. or less, usefully 120° C. or less, preferably 100° C. or less, more preferably ≦80° C., more preferably ≦60° C., most preferably ≦50° C. and in particular at room (ambient) temperature. Higher temperatures are not preferred as it is believed that intermolecular amidation may then occur.

Usefully the process of the invention may be performed at a reduced pressure (less than one atmosphere) to remove alcohol produced, for example at a pressure of less than 0.1 Bar, more preferably less than 50 mBar, for example about 30 mBar. It is preferred to start reducing the pressure of the reaction only after ester bonds can no longer be detected (e.g. by proton MNR or FTIR) in the reaction mixture.

The applicant has found that amine functional polyamides of the invention are useful as cross linkers for isocyanate functional polymers as they react virtually instantaneously with NCO groups.

Thus the applicant has discovered it is possible to synthesize primary amine functional hyperbranched polyamide using the above process. All analyses indicate that the desired amino functional structure is formed.

Typically the reaction speed of the Michael addition is very fast resulting in 100% conversion of the unsaturation of the diester (such as DEF).

The second reaction, the amidation, is also fast and occurs readily at room temperature. However it is preferred to perform the process (step (a) slightly higher than room temperature and under reduced pressure more easily to remove the solvent, water, and the ethanol formed during the reaction. The boiling point of the preferred amines is not very high (and so for this reason so conveniently the reaction temperature is not too high and the reduced pressure not too low so that significant amounts amine (are removed as this would change the molar ratio (Rt) with the diester which might result in gelation. Alternatively if the process conditions are such that diamine is removed, sufficient amine can be added during the reaction to maintain the molar ratio Rt within the ranges specified herein. Optionally amine concentration in the reaction mixture can be monitored continuously to facilitate this.

A further aspect of an embodiment of the polymers the present invention provides an amino functional polyamide obtained and/or obtainable by the process of the present invention.

A still further embodiment of the polymers of the present invention provides one or more amino functional polyamide molecules represented by Formula 1;

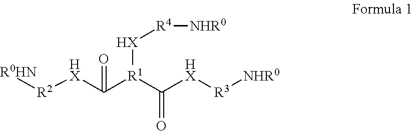

in which
X is independently in each case and of each other N or S,
R⁰ is independently in each case and of each other represent H or C₁₋₆hydrocarbo, provided at least one R⁰ is H.
R¹ is independently in each case a C₂₋₆hydrocarbylyne [preferably C₂₋₆alkylyne, more preferably ethylyne];
R², R³ and R⁴ independently in each case and of each other represent a moiety selected from the group consisting of:
C₂₋₆hydrocarbylene [preferably C₂₋₆alkylene, more preferably ethylene]; and a divalent or trivalent linking moiety of Formula 2:

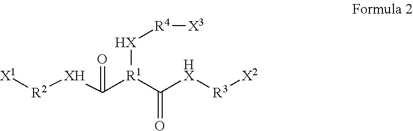

in which
X, R¹, R², R³ and R⁴ are independently in each case and of each other are defined as above; and
X¹, X² and X³ independently in each case and of each other represent:
(i) an amino group (—NH₂);
(ii) a direct single bond from the atom to which they are attached to the molecule of Formula 1 or to a further moiety of Formula 2; and/or
(iii) a divalent imino (—NH—) group attached to a molecule of Formula 1 or a further moiety of Formula 2;
(iv) a secondary amine radical (—NHR)
   where at least two of X¹, X² and X³ represent a bond [option (i)] or imino [option (ii)]; with the proviso that where any of X¹, X² or X³ denote the imino group [option (ii)] in that case they are not directly attached to another nitrogen atom in Formula 1 or 2.

It can be seen that successive polycondensation reactions between intermediate products can result in large molecules comprising many moieties of Formula 2.

Conveniently each instance of R¹ is the same in each molecule of Formula 1 and/or moiety of Formula 2.

Conveniently each instance of R² is the same in each molecule of Formula 1 and/or moiety of Formula 2.

Conveniently each instance of R³ is the same in each molecule of Formula 1 and/or moiety of Formula 2.

Conveniently each instance of R⁴ is the same in each molecule of Formula 1 and/or moiety of Formula 2.

Conveniently R², R³ and R⁴ are the same in each molecule of Formula 1 and/or moiety of Formula 2.

Molecules and/or moieties of Formulae 1 and/or 2 may represent the part or the whole of a polymer i.e. these molecules may comprise a portion or whole of a polydisperse mixture that comprise different molecules. Thus some or all of the components of a polydisperse polymer of the invention may be represented by Formulae 1 and/or 2.

The present invention comprises both these molecules and polymeric mixtures of which they comprise a part. Preferred polydisperse polymers of the present invention may comprise those in which molecules of Formulae 1 and/or 2 comprise at least 1%, more preferably ≧2%, most preferably ≧5% (and in particular ≧10%) by weight of the polydisperse polymer. Conveniently polydisperse polymers of the present invention comprise those in which molecules of Formulae 1 and/or 2 comprise up to 90%, more preferably ≦92%, most preferably ≦95%, (and in particular approximately 100%) by weight of the polydisperse polymer.

Preferred polymers of the invention comprise one or more molecules selected from the group consisting of Group Z below. It is particularly preferred that molecules of the invention are highly branched macromolecules such as hyperbranched polymers.

The weight average molecular mass (M_{w}) of polymers of the invention is generally from 300 to 60,000 conveniently 800 to 50,000, preferably from 1000 to 25,000, more preferably from 2000 to 20,000, most preferably from 5000 to 15,000 daltons.

The number average molecular mass (Mₙ) of polymers of the invention is generally from 300 to 18,000 conveniently 500 to 15,000, preferably from 700 to 10,000, more preferably from 800 to 6,000, most preferably from 1,000 to 4,000 daltons

The primary amine functionality of the polyamides of the invention is generally from 2 to 250 and preferably from 3 to 100, more preferably from 4 to 50, for example from 6 to 30.

The amide functionality of the polyamides of the invention is generally 2 to 250 and preferably from 3 to 100, more preferably from 4 to 50, for example from 6 to 30.

Functionality above is the average number of groups of the specific type per molecule in the polymer composition.

The degree of branching and the functionality of the polymer are dependent on the starting materials and the molecular weight of the polymer. A molecular weight higher than 2000 generally leads to highly branched structures with a functionality of >10.

The process of the invention is now more fully explained below where the diester may be denoted by B₃ (to indicate there are 3 amine-reactive groups thereon (i.e. that are capable under the conditions of the process of the invention of reacting with primary amine functional groups), namely the 2 ester groups and 1C═C bond) and the diamine may be denoted by A₂ (to indicate there are 2 primary amine groups thereon).

### Diesters (≡B₃)

Usefully diester (i) may be a di(C₁₋₄alkoxy)C₁₋₄alkenedioate.

If the reaction is performed in the presence of water as reagent C as already discussed it is preferred that at least one of the esters of the dialkyl ester should be a primary ester, such as n-alkyl ester more preferably a C₁₋₁₀alkyl ester, most preferably C₁₋₄alky ester, for example methyl or ethyl ester. Even more preferred both alkyl esters are n-alkyl esters, most preferably both are C₁₋₄alkyl esters, more preferably both are methyl or ethyl esters.

Diester (i) is trifunctional with respect to primary amine groups, having 2× alkoxy groups attached to a carbonyl which can undergo trans-amidation; and 1× alkylene group which can undergo Michael addition.

Useful diesters may be compounds of Formula 5:

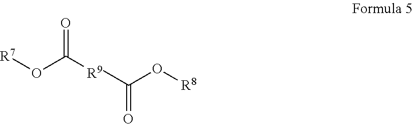

where
R⁷ and R⁸ are independently C₁₋₄alkyl; and
R⁹ is a divalent C₂₋₄hydrocarbo group comprising at least one C═C double bond.

Particularly preferred compounds of Formula 5 may be represented by the structure

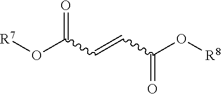

where R⁷ and R³ are C₁₋₄alkyl, preferably methyl or ethyl, more preferably ethyl. Optionally R⁷ is the same as R⁸ and the compound may be the E or Z isomer.

Suitable optionally substituted maleic or fumaric acid esters for use in the present invention may be represented by the formula

R′₃O(O═C)C(R′₁)═C(R′₂)(C═O)OR′₄

wherein
R′₁ and R′₂ may be identical or different and represent hydrogen or organic groups (both are preferably hydrogen),
R′₃ and R′₄ may be identical or different and represent organic groups (preferably C₁₋₈hydrocarbo and most preferably methyl or ethyl),

Examples include the dimethyl, diethyl and di-n-butyl and mixed alkyl esters of maleic acid and fumaric acid and the corresponding maleic or fumaric acid esters substituted by methyl in the 2- and/or 3-position. Suitable maleates or fumarates for use in the present invention include dimethyl, diethyl, di-n-propyl, di-isopropyl, di-n-butyl and di-2-ethylhexyl maleates, methylethylmaleate or the corresponding fumarates.

Thus for example particular useful diesters are:

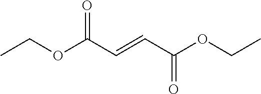

diethyl fumarate (DEF)≡trans-1,2-ethylenedicarboxylic acid diethyl ester≡diethyl 2-but-E-enedioate;

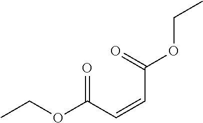

diethyl maleate (DEM)≡cis-1,2-ethylenedicarboxylic acid diethyl ester≡diethyl 2-but-E-enedioate; and/or mixtures thereof.

Another preferred compound of Formula 5 is

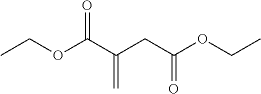

≡diethyl itaconate≡dimethyl 2-methylenebutanedioate.
Dialkyl citraconate and/or dialkyl mesoconate are also preferred diesters,
   Reagent A amines (≡A₂)

In one embodiment of the invention the amine may comprise cyclic and/or aromatic hydrocarbo groups however in another more preferred embodiment the amine comprises alkyl and alkylene groups. As well as one NH₂ group the amine also comprises at least one —SH or one —NHR group.

Usefully the amine may be a anninothiolC₂₋₆alkane ≡C₂₋₆alkylene aminothiol, preferably the amine is unsaturated and/or linear and/or the amino and thiol are both located on different terminal carbons at ends of the alkylene chain.

Other suitable amine-thiol reagents that may be used in the process of the present invention include ethylene amine thiol, 1,2- and 1,3-propane aminethiol, 2-methyl-1,2-propane amine thiol, 2,2-dimethyl-1,3-propane amine thiol, 1,3- and 1,4-butane amine thiol e, 1,3- and 1,5-pentane amine thiol, 2-methyl-1,5-pentane amine thiol, 1,6-hexane amine thiol, 2,5-dimethyl-2,5-hexane amine thiol, 2,2,4- and/or 2,4,4-trimethyl-1,6-hexane amine thiol, 1,7-heptane amine thiol, 1,8-octane amine thiol, 1,9nonane amine thiol, 1,10-decane amine thiol, 1,11-undecane amine thiol, 1,12dodecane amine thiol, 1-amino-3-thiolmethyl-3,5,5-trimethyl cyclohexane, 2,4- and/or 2,6-hexahydrotoluoylene amine thiol, 2,4′- and/or 4,-amino-4′-thiol-dicyclohexylmethane, 3,3-dialkyl-4-amino-4′-thiol-dicyclohexyl methanes (such as 3,3′-dimethyl-4-amino-4′-thiol-dicyclohexyl methane and 3,3′-diethyl-4-amino-4′-thiol-dicyclohexyl methane), 1,3- and/or 1,4-cyclohexane amine thiol, 1,methylamino)-3-thiolcyclohexane, 1,8-p-methane amine thiol, 4-amino-4′-thiol diphenyl methane

Other suitable (primary amine)-(secondary amine) reagents that may be used in the process of the present invention include 1-amino 2-(methyl)amino ethane; 1,2- and 1,3-propane amine (methyl)amine; 1-amino 3-(methyl)amino 2-methyl-1,2-propane; 1-amino 3-(methyl)amino 2,2-dimethyl-1,3-propane; 1,3- and 1-amino, 4-(methyl)amino butane; 1,4-butane1-amine 4-(ethyl)amine; 1,3- and 1,5-pentane amine, 1-amino-6-(isopropyl)amino hexane; 1-amino-3-(methylamine)methyl-3,5,5-trimethyl cyclohexane.

Other suitable secondary amine or thiol substituted analogous of those diamines described in WO2011-076785 may also be used.

More preferred amines are selected from:
ethylene amine thiol (C₂)≡1,2 amino thiol ethane;
1,4-butane amine thiol (ABT)≡

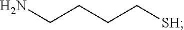

1-amino, 4-(methyl)amino butane≡

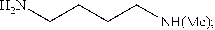

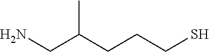

≡1,5-2-methylpentane amine thiol

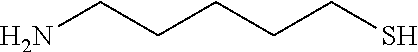

≡1,5-pentane amine thiol;

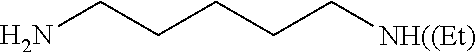

≡1-amino,5-(ethyl)amine pentane;

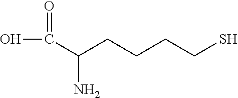

≡1,5-2-carboxypentane amine thiol(C₅)

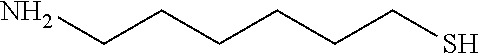

≡hexamethylene-amine thiol (C₆)

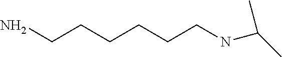

≡1-amino-6-(isopropyl)amino hexane (C₆)
   mixtures thereof; salts thereof and/or different suitable forms thereof (such one or more of those forms described later herein, for example such as sterioisomers and entaniomers).

Amine derivatives formed with certain organic acids such as Itaconic acid (such as suitable salts and ester derivatives thereof) may also usefully be used in the process described herein as may suitable amino acid derivatives

Without wishing to be bound by any theory the applicant believes that in one embodiment of the invention the reaction proceeds analogously to the mechanism described in WO2011-076785.

Broadly another aspect of the present invention provides a compound selected from the group (Group Z) consisting of:

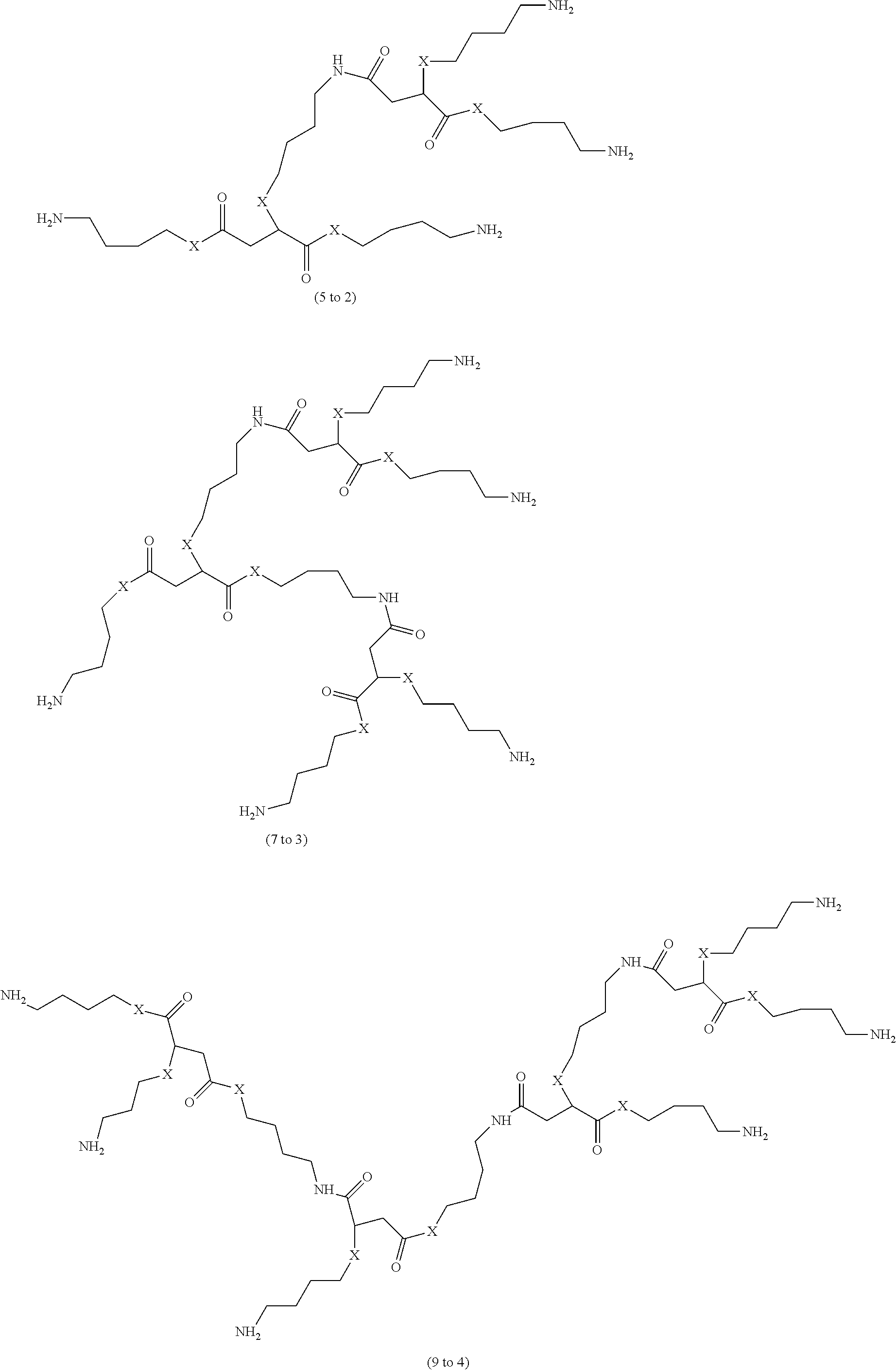

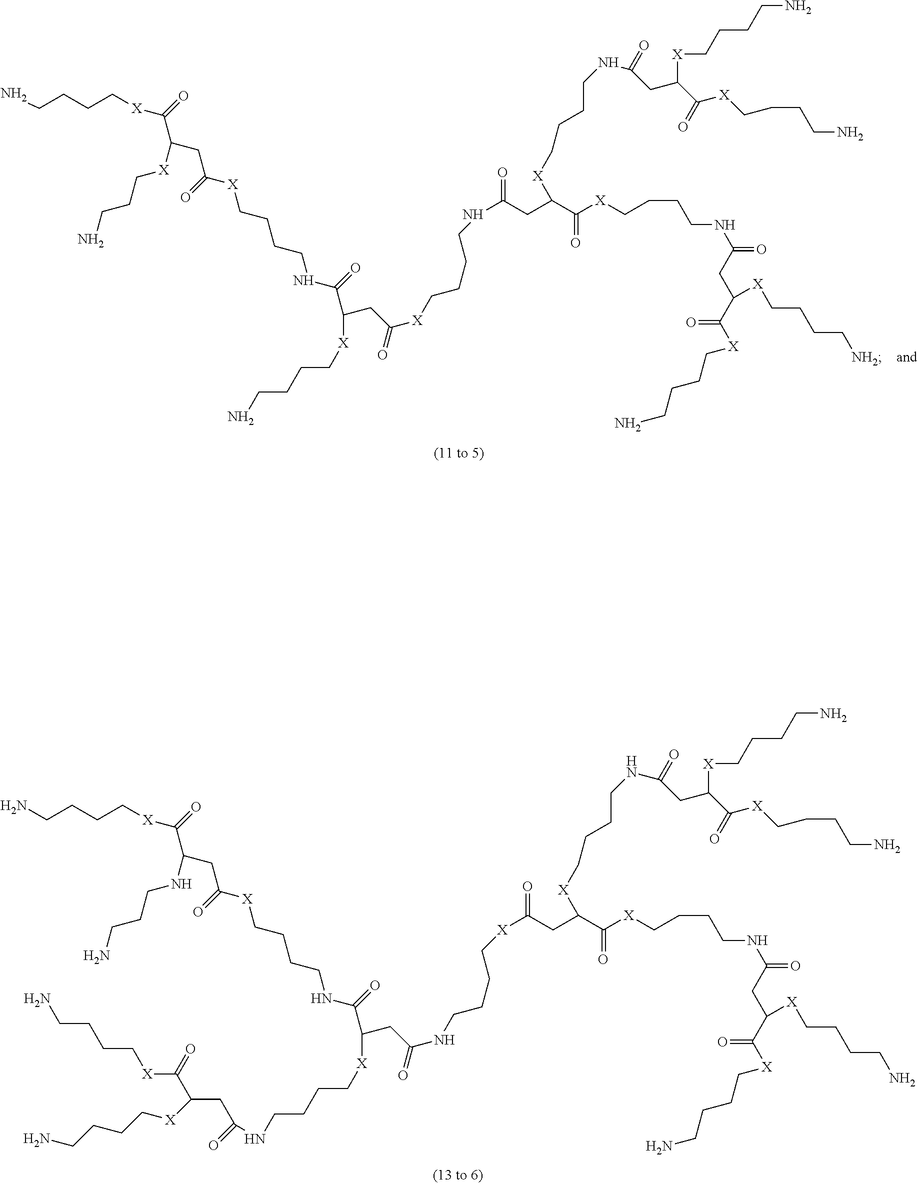

where in the formula above (group Z) X independently denotes SH, NHMe, or NHEt and optionally different forms thereof, such as geometric isomers, enantiomers and/or stereoisomers thereof.

It will be appreciated that analogous groups of structures could be drawn for reaction products that are formed from reacting other unsaturated diesters B with the amines A as described such as any of those specifically described herein.

Broadly yet another aspect of the present invention provides a polydisperse polymeric composition comprising at least one compound selected from those described in Group Z above, and preferably present in the composition in a non trace amount, usefully in an amount of at least 1%, more usefully at least 5%, most usefully at least 10%, in particular at least 20% by weight of the total polymer composition.

Conveniently the at least one compound selected from those in Group Z above is obtained by a polycondensation process (for example the process of the invention as described herein).

Usefully the compositions of the invention do not form a gel after their initial formation. A gel is defined as a substantially dilute crosslinked system, which exhibits no flow when in the steady-state.

More usefully compositions of the present invention do not gel even after storage under standard conditions after 5 days, preferably after 10 days, more preferably after 20 days, most preferably after 25 days.

Conveniently compositions of the invention have a viscosity of less than 2500 mPas, more preferably less than 1700 mPas, most preferably less than 700 mPas.

In a still yet another aspect of the present invention provides a process for the preparation of a multi primary amine functional polymer prepared by adding a) an unsaturated dialkyl ester building block to b) a primary amine containing building block; where the molar ratio of unsaturated dialkyl ester building block (a) to the primary diamine building block (b) is between 1 to 2.01 and 1 to 2.95; and the process is performed so no phase separation occurs.

For any process of the present invention one or more of the following conditions are preferred more preferably all of them:
i) the molar ratio of unsaturated dialkyl ester to Reagent A is between 2.1 and 2.5.
ii) the process is performed at a temperature between 20° C. and the boiling point of the amine (usefully between 20° C. and 100° C., more usefully between 20° C. and 80° C.).
iii) the process is performed at a pressure lower that atmospheric pressure.
iv) the unsaturated dialkyl ester is selected from the group consisting of: dialkyl maleate, dialkyl fumarate, dialkyl itaconate, dialkyl citraconate and dialkyl mesoconate.

A further aspect of the invention provides a polymer obtained and/or obtainable from any process of the invention as described herein, optionally said polymer having a plurality of primary amine functional groups thereon and further optionally also comprising secondary amine and/or amide functional groups.

Conveniently a polymer of the invention (the polymer comprising for example a polydisperse mixture of macromolecules with polydispersity of at least 1.5) comprises (more conveniently substantially comprises) at least one structure selected from the group consisting of Group Z above.

Optionally a polymer of the invention has one or more of the following properties: i) a number molecular weight of at least 300, preferably 500 g/mole; ii) a primary amine content of at least 4, preferably at least 6 moles, more preferably at least 8 moles, —NH₂ groups per macromolecule; iii) a secondary amine content of at least 4 moles preferably at least 6 moles, more preferably at least 8 moles NHR groups per macromolecule; iv) a total primary amine plus secondary amine content of at least 8 moles preferably at least 12 moles, more preferably at least 16 moles per macromolecule; v) an amide content of at least 4 moles, preferably at least 6 moles, more preferably at least 8 moles of —NHC═O— groups per macromolecule; and/or vi) is soluble (preferably completely soluble) in water.

The amine or amide content is calculated above as an average (mean) number of moles of the amine or amide group per macromolecule averaged over the whole polymer (where a polydisperse mixture of macromolecules).

The term “comprising” as used herein means that the list that immediately follows is non exhaustive and may or may not include any other additional suitable items, for example one or more further feature(s), component(s), ingredient(s) and/or substituent(s) as appropriate. The terms ‘substantially free of” and ‘substantially comprising’ as used herein means the following component or list of component(s) is respectively free (i.e. absent) or present in a given material to an extent or in an amount greater than or equal to about 90%, preferably ≧95%, more preferably ≧98% by weight of the total amount of the given material. The term “consisting of” as used herein mean that the list that follows is exhaustive and does not include additional items.

For all upper and lower boundaries of any parameters given herein, the boundary value is included in each range for each parameter. All combinations of minimum and maximum values of the parameters described herein may be used to define the parameter ranges for various embodiments and preferences of the invention.

It will be understood that the total sum of any quantities expressed herein as percentages cannot (allowing for rounding errors) exceed 100%. For example the sum of all components of which the composition of the invention (or part(s) thereof) comprises may, when expressed as a weight (or other) percentage of the composition (or the same part(s) thereof), total 100% allowing for rounding errors. However where a list of components is non-exhaustive the sum of the percentage for each of such components may be less than 100% to allow a certain percentage for additional amount(s) of any additional component(s) that may not be explicitly described herein.

For example the percentages described herein (whether as mole % or weight %) for the composition, polymer (s) and parts thereof (e.g. monomer(s)) relate to the percentage of the total amount of certain specified components (e.g. monomer(s)) from which the relevant polymer or part thereof is obtained and/or obtainable. In one (preferred) embodiment of the invention the components specified sum 100% (e.g. no other monomers or units derived therefrom, comprise the relevant composition, polymer or part thereof). However it will be appreciated that in another embodiment of the invention other components (e.g. monomers or units derived therefrom) in addition to those specified above may also comprises the relevant composition, polymer or part thereof so the components explicitly described herein would then add up to less than 100% of the relevant composition, polymer or part therein.

Unless the context clearly indicates otherwise, as used herein plural forms of the terms herein (for example composition, monomer and/or polymer) are to be construed as including the singular form and vice versa.

The terms ‘optional substituent’ and/or ‘optionally substituted’ as used herein (unless followed by a list of other substituents or the context clearly indicates otherwise) signifies the one or more of following groups (or substitution by these groups): carboxy, sulfo, sulfonyl, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulfonyl if directly attached to each other represent a sulfamoyl group). Preferred optional substituents comprise: carboxy, sulfo, hydroxy, amino, mercapto, cyano, methyl, halo, trihalomethyl and/or methoxy, more preferred being methyl, hydroxy and cyano.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group may be selected from: hydrogen, halo, phosphorus, nitrogen, oxygen, silicon and/or sulphur, more preferably from hydrogen, nitrogen, oxygen, phosphorus and/or sulphur.

Most preferred organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulphinyl, sulphonyl, amino, imino, nitrilo and/or combinations thereof. Organic groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group).

The term ‘hydrocarbo group’ as used herein is a sub-set of a organic group and denotes any univalent or multivalent moiety (optionally attached to one or more other moieties) which consists of one or more hydrogen atoms and one or more carbon atoms and may comprise one or more saturated, unsaturated and/or aromatic moieties. Hydrocarbo groups may comprise one or more of the following groups. Hydrocarbyl groups comprise univalent groups formed by removing a hydrogen atom from a hydrocarbon (for example alkyl). Hydrocarbylene groups comprise divalent groups formed by removing two hydrogen atoms from a hydrocarbon, the free valencies of which are not engaged in a double bond (for example alkylene). Hydrocarbylyne groups comprise triivalent groups formed by removing three hydrogen atoms from a hydrocarbon, the free valencies of which are not engaged in a triple bond (for example alkylyne). Hydrocarbylidene groups comprise divalent groups (which may be represented by “R₂C═”) formed by removing two hydrogen atoms from the same carbon atom of a hydrocarbon, the free valencies of which are engaged in a double bond (for example alkylidene). Hydrocarbylidyne groups comprise trivalent groups (which may be represented by “RC≡”), formed by removing three hydrogen atoms from the same carbon atom of a hydrocarbon the free valencies of which are engaged in a triple bond (for example alkylidyne). Hydrocarbo groups may also comprise saturated carbon to carbon single bonds (e.g. in alkyl groups); unsaturated double and/or triple carbon to carbon bonds (e.g. in respectively alkenyl and alkynyl groups); aromatic groups (e.g. in aryl groups) and/or combinations thereof within the same moiety and where indicated may be substituted with other functional groups

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C_{1-N}organo, signifies a organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable and/or effective.

Preferably any of the organo groups listed herein comprise from 1 to 36 carbon atoms, more preferably from 1 to 18. It is particularly preferred that the number of carbon atoms in an organo group is from 1 to 12, especially from 1 to 10 inclusive, for example from 1 to 4 carbon atoms.

As used herein chemical terms (other than IUAPC names for specifically identified compounds) which comprise features which are given in parentheses—such as (alkyl)acrylate, (meth)acrylate and/or (co)polymer—denote that that part in parentheses is optional as the context dictates, so for example the term (meth)acrylate denotes both methacrylate and acrylate.

Unless the context clearly indicates otherwise it will be appreciated that certain moieties, species, groups, repeat units, compounds, oligomers, polymers, materials, mixtures, compositions and/or formulations which comprise and/or are used in some or all of the invention as described herein may exist as one or more different forms such as any of those in the following non exhaustive list: stereoisomers (such as enantiomers (e.g. E and/or Z forms), diastereoisomers and/or geometric isomers); tautomers (e.g. keto and/or enol forms), conformers, salts, zwitterions, complexes (such as chelates, clathrates, crown compounds, cyptands/cryptades, inclusion compounds, intercalation compounds, interstitial compounds, ligand complexes, organometallic complexes, non-stoichiometric complexes, π-adducts, solvates and/or hydrates); isotopically substituted forms, polymeric configurations [such as homo or copolymers, random, graft and/or block polymers, linear and/or branched polymers (e.g. star and/or side branched), cross-linked and/or networked polymers, polymers obtainable from di and/or tri-valent repeat units, dendrimers, polymers of different tacticity (e.g. isotactic, syndiotactic or atactic polymers)]; polymorphs (such as interstitial forms, crystalline forms and/or amorphous forms), different phases, solid solutions; and/or combinations thereof and/or mixtures thereof where possible. The present invention comprises and/or uses all such forms which are effective as defined herein.

The terms ‘effective’, ‘acceptable’ ‘active’ and/or ‘suitable’ (for example with reference to any process, use, method, application, preparation, product, material, formulation, compound, monomer, oligomer, polymer precursor, and/or polymers of the present invention and/or described herein as appropriate) will be understood to refer to those features of the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products.

One utility of the present invention comprises use of the amino functional polymers of the invention as a cross-linker for materials (such as other polymers) that will react with the amino groups.

One aspect of the present invention provides for use.in a composite material (preferably in concrete, more preferably in concrete admixtures, most preferably as a superplasticizing additive for concrete admixtures); of a substantially gel free non dendritic polymer R having a polydispersity of at least 1.1, a weight average molecular weight of at least 300 daltons, and comprising at least one primary amino group, the polymer R being obtained from a process comprising the step of reacting: Reagent A, a compound comprising at least one amino group (—NH2) and one functional group selected from the group consisting of a further amino group (—NH2), thiol (—SH) and a secondary amine radical (—NHR); (where R denotes a hydrocarbo group) and Reagent B, an alpha-beta unsaturated Michael-reactive ester comprising a plurality of ester groups; where the molar ratio (denoted by Rt) of Reagent A to Reagent B is more than one and less than three.

Another aspect of the present invention provides a composite material that comprises a substantially gel free non dendritic polymer R having a polydispersity of at least 1.1, a weight average molecular weight of at least 300 daltons, and comprising at least one primary amino group, the polymer R being obtained from a process comprising the step of reacting: Reagent A, a compound comprising at least one amino group (—NH2) and one functional group selected from the group consisting of a further amino group (—NH2), thiol (—SH) and a secondary amine radical (—NHR); (where R denotes a hydrocarbo group) and Reagent B, an alpha-beta unsaturated Michael-reactive ester comprising a plurality of ester groups; where the molar ratio (denoted by Rt) of Reagent A to Reagent B is more than one and less than three. Preferred composite materials of the invention comprise concrete, more preferably concrete admixtures.

The term concrete is well known to those skilled in the art. Concrete generally denotes a composite material comprising water with an aggregate (typically coarse aggregate such as gravel and/or crushed rock often limestone or granite combined with a fine aggregate such as sand) together with cementitious materials as a binder (such as Portland cement, fly ash and/or slag cement). Other additives (including as described herein) may be added.

Further uses and definitions of what is meant by additive for concrete and/or concrete admixtures are known in the industry and for example are described and defined by the Portland Cement Association (PCA) such as in their PCA Manual Chapter 6 “Admixtures for Concrete” and the content of this chapter is incorporated herein by reference.

Thus for example PCA define admixtures as being those ingredients in concrete other than portland cement, water, and aggregates that are added to the mixture immediately before or during mixing. Admixtures can be classified by any of the following functions: air-entraining admixtures; water-reducing admixtures; plasticizers; accelerating admixtures; retarding admixtures; hydration-control admixtures; corrosion inhibitors; shrinkage reducers; alkali-silica reactivity inhibitors; coloring admixtures; and/or miscellaneous admixtures for other purposes such as workability, bonding, dampproofing, permeability reducing, grouting, gas-forming, antiwashout, foaming, and/or pumping admixtures.

In a further embodiments of the present invention broadly provide use of the polyamines described herein as additives for concrete admixtures where the additive improves the processability of the concrete admixtures; improves the processability of the concrete admixtures as a superplasticizer; improves the performance and/or properties of an article and/or structure formed from (in whole or in part) said concrete admixture; reduces the shrinkage of an article and/or structure formed from (in whole or in part) said concrete admixture; and/or increases the strength of said concrete admixture (preferably within 24 hours of addition to the admixture). Adding the polyamines additives of the invention (or as described herein) to concrete allows the amount of cement in the mortar to be reduced.

A still yet further aspect of the present invention provides for a method of reacting a polymer of the invention by mixing with a second polymer comprising groups thereon which react with amino groups, and reacting the polymers together to form a cross-linked polymeric network.

A yet other aspect of the invention provides a polymeric network (such as a coating) obtained and/or obtainable by the method of the invention. Other aspects of the invention provide an article coated with a coating of the invention and use of a polymer of the invention as a cross-linker (optionally in the method of the invention).

As used herein, unless the context indicates otherwise, standard conditions (e.g. for drying a film) means a relative humidity of 50%±5%, ambient temperature (23° C.±2°) and an air flow of less than or equal to (≦) 0.1 m/s. ‘Ambient temperature’ (also referred to herein as room temperature) denotes 23° C.±2°.

Polyethylenimines (PEI) are well known branched, spherical polymeric amines available commercially from many sources. PEIs typically absorb well onto negatively charged surfaces and are applied to a wide variety of substrates and materials such as cellulose, polyesters, polyolefins, polyamides and metals. They can bind together dissimilar surfaces to prevent separation and/or add new properties to the surface. PEIs ares used in a wide variety of well known applications such as any of the following:

On plastics,
A) as adhesion promoters (for example between different types of plastics and/or between plastics and polar substrates, such as polyolefin films and paper)
B) to improve dye acceptance, paintability, and/or barrier properties.
C) in lamination inks e.g. to act as a tie-bond for the plastic film placed over the substrate;
   In coatings, colours and/or adhesives,
D) to make coatings, colours and/or adhesives stick better to porous and non-porous surfaces;
E) to act as a primer for radiation curable (e.g. EB or UV) coatings;
F) as a hardener in epoxy resins;
G) to improve rain resistance in architectural plasters and paints;
H) to improve pigment dispersion for easier compound processing and/or higher colour strength.

### With Metals

I) to chelate heavy metals, preferably strongly, selectively, and/or reversibly, for example in waste water;
J) to make diverse substances adhere to metals and thus improves the effectiveness of lubricants, detergents, and/or corrosion inhibitors.
K) to make difficult-to-dissolve metal salts soluble.
   On Textiles and Fibres (e.g. Fibre Glass)
L) to form the basis of lubricants that improve processing of brittle fibres
M) to improve dye fixation, hydrophilicity, and/or anti-static properties of textile fibres.
N) to enhance water- and shrink proofing of textiles.

### Water Treatment

O) to aggregate finely distributed proteins as a flocculant of waste water sludge.
P) to flocculate particles with high anionic charge, for example zeolites;
R) as a coagulant group e.g. in latex coagulation and/or as flocculant in water treatment applications e.g. biological flocculant
S) In industrial and municipal raw and process water treatment, for example in specialty wastewater treatment applications (typically sold as an aqueous solution of 20-50% active solids content),
T) in flotation processing e.g. for treating oily wastewater;

### Miscellaneous

U) Paper—As adjuncts to polyacrylamides in retention and drainage aids for paper production and can increase the solids in the waste, To improve fixative performance, in removing “white trash,” like residual coatings/binders (for example styrene-butadiene and styrene-acrylic resins) from recycled paper occurring in the closed water circle of the paper production process.
V) mineral processing,—as flocculants in mineral processing, in coal mining; oil field—as drilling mud additives in petroleum production.
W) Other applications—in coatings, inks, adhesives, packaging, personal care, textiles and/or corrosion inhibition.
X) Use as additives in composite materials and particularly in concrete, for example in concrete admixtures by increasing strength, improve processing of concrete (superplasticizer) and/or reducing shrinkage.

### Chemical Modification of Polymer R can Expand the Range of Uses of Polymer R, for Example:

Y) Amidation with fatty acids, for example may lead to amphiphilic Polymer R suitable as pigment dispersants for non-polar solvents.
Z) Alkoxylation (e.g. with alkylene oxides) may reduces the amount of primary and secondary amino groups and therefore improve the compatibility of Polymer R with highly anionic compounds in formulations.
AA) Carboxylation (e.g. with acrylic and/or maleic acids) may yield amphoteric Polymer R with excellent chelating and dispersing properties.

The polyaminoamide polymers of the invention herein (Polymer P) and/or those polymers described in the applicant's co-pending patent application WO2011-076785 (polymer N) (both types together known as Polymer R) can be used as a direct replacement for PEI.

In a yet further aspect of the present invention comprises use of the polymers R (optionally as a replacement for polyethylene imine (PEI)) to bind together dissimilar surfaces to prevent separation and/or add new properties to the surfaces, preferably on plastics; in coatings, colours and/or adhesives; with metals; on textiles and fibres; in water treatment, paper, mineral processing and/or chemically modified; and more preferably in one or more of any of the applications described above (e.g. labelled A to Z).

In a yet further aspect of the present invention comprises use of polymers R in any of the following methods:
I) Polymer R (e.g. those having a lyamine functional group thereo)n can be reacted with glycerol carbonate methacrylate to give both OH and methacrylate functionality. The resulting product can be cured by irradiation (e.g. with used UV) and/or by use of isocyanates, to produce a system which is potentially 100% solids. These polymers are relatively easy to synthesis as methacrylates (other than acrylates) hardly react via Michael addition making their synthesis relatively straightforward.
II) Polymer R may used as a polyamine in road paints as alternative to other polyamines like poly DMAEMA. The polymer R may be combined with a latex at high pH and upon drying, a fast coagulation will give a dry coating very rapidly, especially when also formulated with some methanol.
III) Polymer R may be used as a polyamine that can be partly reacted with fatty acids, preferably unsaturated, followed by reaction of the remaining amines with anhydrides, which will give relatively hydrolysis resistant products (large distance between the free COOH and an ester bond). The product may either be the binder itself or this may be a useful route to create a new class of COOH functional autoxidisable dispersants, e.g. to disperse alkyd resins or as formulation additive.
IV) Polymer R polyamines may be combined with polyunsaturated radiation curable (e.g. UV curable) oligomers. Since both have a functionality >2, a high crosslink density can be obtained to produce excellent solvent resistance and mechanical performance. If either the Polymer R or polyunsaturated resin are crystalline a powder formulation may be produced.
V) Polymer R can be used as a crosslinker for systems with pendant carbonate groups such as those poly(meth)acrylates produced by copolymerisation of glycerol carbonate methacrylate. These systems can be prepared as two component systems (the approach which is preferred) although also one pack may be considered, especially when the polyamine is sufficiently water soluble. Improvement of shelf life is achievable with for instance ‘blocking’ the polyamine with a volatile acid, which evaporates on drying, thus liberating the acid group for reaction with the carbonate functionality.
VI) Polymer R can be used as a hydrazine free primer for substrates (such as OPP films). Currrent primers are typically urethanes are over-extended with hydrazine. The use of hydrazine is not allowed according to latest European Food Contact legislation. Polymer R type polyaminoamides can be used as an alternative for hydrazine in this application.

The processes described in A) to Z) and/or I) to V) and the polymers and/or formulations so described also independently form further aspects and embodiments of the present invention.

Polymer R (the polyaminoamides (polymer P) as described herein and the polymers in WO2011-076785 (polymer N)) may also be used in any of the following other applications:
Modfiying (another) resin;
Additive for resins
Cross-linker
Improved release from casting moulds/wax replacement
Carrier for homogenous catalyst
Processing agent
Imine replacement to improve wet adhesion
UV absorber
Inhibit corrosion (especially in oil field applications)
As gelling agent
In any known applications where dendrimers may be used (such as drug delivery, sustained release or encapsulation)
Use in cosmetics,
Use in hair care
Carrier for enzymes
Method for increasing molecular weight of polymers
Method for increasing/adding water-soluble/hydrophilic/anioinc groups to polymers
Method to quicken drying
Additive for concrete

Many other variations embodiments of the invention will be apparent to those skilled in the art and such variations are contemplated within the broad scope of the present invention.

Further aspects of the invention and preferred features thereof are given in the claims herein if not already described herein.

### EXAMPLES

The present invention will now be described in detail with reference to the following non limiting examples which are by way of illustration only which can be prepared in the following standard method described below, in combination with the tables.

Primary Amines with Thiol or Secondary Amine Groups (Reagent A)
1-amino butane 4-thiol (ABT), (mw=105)
1-amino, 4-(methyl)amino butane [A(M)A)B] (mw=102)
1,6-aminohexane thiol (AHT). (mw=133)
1-amino,5-(ethyl)amino 2-methylpentanediamine)A(EA)MP (mw=144)

### Unsaturated Diesters (Reagent B)

diethyl fumarate (DEF), diethyl maleate (DEM), dimethyl itaconate (DMI).

### Standard Method (Weights Rounded to Nearest Gram)

Part 1—To ‘a’ grams of amine A in a reaction vessel can be added ‘b’ grams of unsaturated diester B over ‘c’ minutes. The proportion of diamine to unsaturated diester is R. An exothermic reaction resulted heating the mixture to ‘d’° C. A sample can be taken and analysed with FTIR, H-NMR and viscosity can be measured. The reaction vessel is then heated to 80° C. in an oil bath to raise the temperature of the reaction mixture to ‘e’° C. and this temperature can be maintained until FTIR and H-NMR analysis of samples taken during the reaction shows that all the ester groups had reacted.

Part 2—The oil bath was kept at 80° C. and the pressure of the reaction vessel was reduced to the maximum pressure at which (given its boiling point) the free amine monomer remained in the reaction mixture. The reduced pressure was maintained until all volatile components and as much water as possible had been removed from the reaction mixture. A final product can be obtained which can be characterised using Fourier Transform Infrared Spectroscopy (FTIR), NMR (proton and/or ¹³C), viscosity measurements, amine titration and/or liquid chromatography mass spectrometry (LC-MS). In the Tables below aq denotes water as solvent, am denotes liquid ammonia as solvent (in the amounts given as 100%-amine %, ie both are Reagent C)

Synthesis of A₂B₃ 5/2 resins (Ex 1 to 6)

| | | | | | | | | |
|---|---|---|---|---|---|---|---|---|
| | | | | | ‘c’ | | ‘d’ | ‘e’ |
| Ex | Amine (A) | ‘a’ g | Ester | ‘b’ g | mins | R | ° C. | ° C. |

Reagent A = Amino-Thiol

| | | | | | | | | |
|---|---|---|---|---|---|---|---|---|
| 1 | 67.3% aq ABT | 246 | DEF | 110 | 30 | 5/2 | 48.3 | 74.2 |
| 2 | 67.3% am AHT | 313 | DEF | 110 | 30 | 5/2 | 48.3 | 74.2 |

Reagent A = Amino-Secondary amine

| | | | | | | | | |
|---|---|---|---|---|---|---|---|---|
| 3 | 67.3% aq A(AE)MP | 337 | DEF | 110 | 30 | 5/2 | 48.3 | 74.2 |
| 4 | 67.3% am A(MA)B | 240 | DEM | 110 | 30 | 5/2 | 48.3 | 74.2 |

Synthesis of A₂B₃ 9/4 resins (Ex 5 to 8)

| | | | | | | | | |
|---|---|---|---|---|---|---|---|---|
| | | | | | ‘c’ | | ‘d’ | ‘e’ |
| Ex | Amine | ‘a’ g | Ester | ‘b’ g | mins | R | ° C. | ° C. |

Reagent A = Amino-Thiol

| | | | | | | | | |
|---|---|---|---|---|---|---|---|---|
| 5 | 67.3% am ABT | 188 | DEF | 95 | 30 | 9/4 | 51.1 | 72.6 |
| 6 | 67.3% aq AHT | 240 | DEF | 95 | 30 | 9/4 | 51.1 | 72.6 |

Reagent A = Amino-Secondary amine

| | | | | | | | | |
|---|---|---|---|---|---|---|---|---|
| 7 | 67.3% am | 256 | DEF | 95 | 30 | 9/4 | 51.1 | 72.6 |
| | A(AE)MP | | | | | | | |
| 8 | 67.3% aq A(MA)B | 183 | DEM | 95 | 30 | 9/4 | 51.1 | 72.6 |

The Resins of Examples 1 to 8 can be formulated with conventional ingredients into a coating composition in a conventional manner which can be used in any of the uses described herein.

The examples described in copending application WO2011-076785 are incorporated herein by reference any of these may be used in the various methods, formulations and uses as described and claimed herein.

1. A process for the preparing a substantially gel free polymer P having a polydispersity of at least 1.1 and a weight average molecular weight of at least 300 daltons, the polymer P comprising primary amino groups, the process comprising the step of reacting
Reagent A, a compound comprising at least one amino group (—NH₂) and one functional group selected from the group consisting of a further amino group (—NH₂), thiol (—SH) and a secondary amine radical (—NHR); (where R denotes a hydrocarbo group) and
Reagent B, an alpha-beta unsaturated Michael-reactive ester comprising a plurality of ester groups;
where the molar ratio (denoted by Rt) of Reagent A to Reagent B is more than one and less than three and where the Polymer P is not a dendrimer.

2. A process as claimed in claim 1 in which Reagent A comprises a compound comprising at least one amino group (—NH₂) and one functional group selected from the group consisting of a thiol (—SH) and a secondary amine radical (—NHR); (where R denotes a hydrocarbo group).

3. A process as claimed in claim 1, where the polymer P is a hyperbranched polyamide and
Reagent A comprises at least one aminoC₁₋₁₂hydrocarbon (preferably a aminoC₁₋₁₀alkane) substituted by at least one thiol and/or secondary amine radical; and
Reagent B comprising at least one di(C₁₋₁₂hydrocarbo-oxy)C₃₋₁₀hydrocarbo-enedioate (preferably a di(C₁₋₆alkoxy)C₄₋₆alkenedioate) ester) and/or anhydride thereof;
where Rt is in the range from 1.1. to 2.9

4. A process as claimed in claim 1 where the reaction is carried out in the presence of Reagent C where Reagent C is capable under the conditions of the reaction of cleaving ester [—C(O)═O] bonds to form moieties which are not capable of undergoing Michael addition; and Reagent C is present in sufficient amounts to avoid gelation.

5. A process as claimed in claim 4, where Reagent C is selected from NH₃ and/or H₂O

6. A process as claimed in claim 4, where Reagent C is present in an amount defined by at least one of i), ii) and/or iii) where
i) at least 0.01 moles (based of the total moles of Reagents A and B).
ii) where the ratio Rc is at least 0.01, where Rc denotes the ratio of functional groups based on the total number of ester cleaving functional groups present on Reagent C compared to the total amount of ester groups present in Reagent B; and/or.
iii) in an amount of at least 3.0% by weight (based of the total amount of Reagents A and B).

7. The process as described in claim 1 where Reagent A is selected from the group consisting of:
1-amino butane 4-thiol (ABT), 1-amino, 4-(methyl)amino butane [A(M)A)B] 1,6-aminohexane thiol (AHT), 1-amino,5-(ethyl)amino 1-amino,5 (ethyl)amino 2 methylpentanediamine)A(EA)MP, isomers thereof and mixtures thereof.

8. The process as described in claim 1 where, Reagent B is selected from the group consisting of: dialkyl maleate, dialkyl fumarate, dialkyl itaconate, dialkyl citraconate, dialkyl mesoconate and mixtures thereof.

9. A non dendrimer polymer P comprising primary amino groups, obtained and/or obtainable from a process as described in claim 1.

10. A method of reacting a polymer P as claimed in claim 9 comprising the step of: reacting the amino functional polymer P with a second polymer comprising groups thereon which react with amino groups to form a polymeric product, optionally a polymeric network.

11. A coating comprising a polymer as claimed in claim 9.

12. An article coated with a coating as claimed in claim 11.

13. Use of a polymer R to bind together dissimilar surfaces to prevent separation and/or add new properties to the surfaces (optionally as a replacement for polyethylene imine (PEI); where
Polymer R comprises a Polymer P as claimed in claim 9 and/or a Polymer N obtained from a process for the preparing a substantially gel free polymer N (i.e. not a dendrimer) comprising primary amino groups, the process comprising the step of reacting Reagent A, a compound comprising at least two amino groups;
and Reagent B, an unsaturated ester comprising a plurality of ester groups;
where the molar ratio (denoted by Rt) of Reagent A to Reagent B is more than one and less than three.

14. Use as claimed in claim 13 of Polymer P and/or N on plastics; in coatings, colours and/or adhesives; with metals; on textiles and fibres; in water treatment, paper, mineral processing and/or chemically modified.

15. A polymer obtained and/or obtainable by modifying the amino groups on Polymer P (the polyaminoamide as claimed in claim 9) by one of more of the following reactions:
a) amidation (e.g. with fatty acids).
b) alkoxylation (e.g. with alkylene oxides); and/or.
c) carboxylation (e.g. with acrylic and/or maleic acids).

16. An (optionally radiation curable) hydroxyl and methacrylate functional polymer obtained and/or obtainable by reacting Polymer P (a polyaminoamide as claimed in claim 9), with a polyol carbonate methacrylate.

17. A paint (optionally suitable for application to roads), the paint comprising Polymer P (a polyaminoamide as claimed in claim 9), optionally in combination with a high pH polymer latex and methanol.

18. A carboxylic acid functional polymer obtained and/or obtainable by the process of:
a) reacting some of the amino groups in Polymer P (a polyaminoamide as claimed in claim 9), with an optionally unsaturated fatty acid; and then
b) reacting substantially all of the remaining amino groups with an anhydride, and/or precursor thereof.

19. A crosslinker comprising a mixture of Polymer P (a polyaminoamide as claimed in claim 9), with a polyunsaturated radiation-curable (e.g. UV curable) oligomer.

20. Use of Polymer P (a polyaminoamide as claimed in claim 9), as a crosslinker for polymeric systems with pendant carbonate groups [such as those poly(meth)acrylates produced by copolymerisation of glycerol carbonate methacrylate].

21. A hydrazine free primer for polymeric substrates (such as OPP films). Comprising a polyurethane extended with a Polymer P (a polyaminoamide as claimed in claim 9).

22. Use of Polymer P (a polyaminoamide as claimed in claim 9) bitorin at least one of the following applications:
resin modifier,
additive,
cross-linker,
release agent to improve release from casting moulds and/or replace wax therein;
carrier for homogenous catalyst
processing agent
Imine replacement to improve wet adhesion
UV absorber
corrosion inhibitior (especially in oil field applications)
gelling agent
as means to encapsulate an active agent (such as a pharmaceutically active agent) optionally for sustained release and/or delivery of said agent
use in cosmetics and/or hair care,
carrier for enzymes
method for increasing molecular weight of polymers
method for increasing/adding water-soluble/hydrophilic/anioinc groups to polymers
method to quicken drying
and/or any suitable combinations thereof.

23. Use of hyperbranched polyamine as an additive for composite compositions.

24. Use of hyperbranched polyamine as an additive as claimed in claim 23.

25. A composite composition comprising a hyperbranched polyamine.

26. A composite composition as claimed in claim 25 in which the hyperbranched polyamine comprises a polymer P.

27. A composite composition as claimed in either claim 25 which comprises a concrete composition and/or concrete admixture.

28. An article and/or structure comprising a composite composition as claimed in claim 25.

29. An article and/or structure as claimed in claim 28 which is an architectural and/or engineering structure and/or part thereof and/or component thereof.

30. Use as claimed in claim 23, where the polyamine is an additive for a concrete composition and/or concrete admixture as claimed in claim 27.

31. Use as claimed in claim 30, where the additive improves the processability of the concrete composition and/or concrete admixture as claimed in claim 27.

32. Use as claimed in claim 30, where the additive improves the processability of the concrete composition and/or concrete admixture as a superplasticizer.

33. Use as claimed in claim 30, where the additive improves the performance and/or properties of the article and/or structure.

34. Use as claimed in claim 30, where the additive reduces the shrinkage of the article.

35. A method of construction comprising use of a composite composition as claimed in claim 25.

36. A method of construction as claimed in claim 35 of an article and/or structure.

37. A method of construction comprising the steps of
(a) adding a hyperbranched polyamine comprising a polymer P as claimed in claim 9, to a composite composition preferably comprising a concrete composition and/or concrete admixture; and
(b) forming an article and/or structure (preferably an architectural and/or engineering structure and/or part thereof and/or component thereof) from the composite composition obtained from step (a).
